(19) United States
(12) Patent Application Publication
(10) Pub. No.: US 2026/0296487 A1
(43) Pub. Date: Oct. 1, 2026

(54) ESTIMATION DEVICE, ESTIMATION METHOD, AND NON-TRANSITORY COMPUTER READABLE STORAGE MEDIUM

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Taiki NII, Nisshin-shi (JP); Nobuaki MATSUDAIRA, Nisshin-shi (JP); Tomohiro NEZUKA, Nisshin-shi (JP); Ryusuke OHATA, Nisshin-shi (JP); Takafumi OOWADA, Nisshin-shi (JP)

(21) Appl. No.: 19/550,830

(22) Filed: Feb. 26, 2026

(30) Foreign Application Priority Data
Mar. 28, 2025 (JP) 2025-055261

(51) Int. Cl. B60W 60/00; G01C 21/16; G06T 7/73

(52) U.S. Cl. CPC B60W 60/001; G01C 21/1656; G06T 7/73; B60W 2420/403; B60W 2520/28; B60W 2554/20; B60W 2554/4029; G06T 2207/30252

(57) ABSTRACT

An estimation device includes a coordinate calculation unit, an information integration unit, and a generation unit. The coordinate calculation unit calculates a group of three-dimensional coordinates that represent a position of an element disposed in the environment around the vehicle based on a two dimensional image. The information integration unit acquires a reliability score corresponding to a reference parameter from among a plurality of types of parameters related to a reliability of the three-dimensional coordinates, and identification key information. The information integration unit generates a data point by integrating the three-dimensional coordinates and the reliability score based on the identification key information. The generation unit generates visual information from generated plurality of data points using a machine learning model that has been trained in advance to generate the visual information that visually represents the element.

### CROSS REFERENCE TO RELATED APPLICATION

The present application claims the benefit of priority from Japanese Patent Application No. 2025-055261 filed on Mar 28, 2025. The entire disclosure of the above application is incorporated herein by reference.

### TECHNICAL FIELD

The present disclosure relates to an estimation device, an estimation method, and non-transitory computer readable storage medium.

### BACKGROUND ART

In recent years, the development of autonomous driving technique has progressed. The autonomous driving technique requires accurate recognition of the environment around the vehicle. The environment around the vehicle includes, for example, other vehicles, pedestrians, and the positions of lanes around the vehicle. In order for the autonomous driving technique to determine a proper driving route, it is required that the vehicle is able to accurately recognize the environment around the vehicle.

LiDAR (i.e., Light Detection and Ranging) is known as a technique for recognizing the environment around the vehicle. The LiDAR irradiates laser light onto an object and measures the time and intensity of the reflected light. This allows the LiDAR to measure the distance to an object and the shape of the object with high accuracy. However, the LiDAR devices are expensive compared to sensors such as radar and cameras. For this reason, research is being conducted into technologies that use cheaper cameras to recognize the environment around the vehicle.

Such a technique is disclosed in, for example, a conceivable technique. The technique described in the conceivable technique estimates three-dimensional spatial information about the surroundings of the vehicle by using a machine learning model based on two-dimensional images acquired by multiple cameras. The technique of the conceivable technique further generates a bird's-eye view based on the estimated three-dimensional spatial information. By applying the technique of the conceivable technique, it is possible to recognize the environment around the vehicle.

Another known technique for estimating three-dimensional spatial information based on two-dimensional images without using machine learning models is VO (i.e., Visual Odometry). The VO tracks feature points on multiple consecutive two dimensional images and estimates three dimensional spatial information based on the feature points. A feature point is a point, such as an edge or corner of an object, that is easily distinguishable from surrounding pixels.

### SUMMARY

According to an example, an estimation device is mounted on a vehicle equipped with a plurality of cameras. The estimation device includes: at least one processor with a memory storing computer program code. The at least one processor with the memory may be configured to cause the estimation device to execute: calculating a group of three-dimensional coordinates representing a position of an element disposed in an environment around the vehicle using visual odometry based on a two-dimensional image acquired by at least one of the plurality of cameras; acquiring each three-dimensional coordinate of the group of the three-dimensional coordinates; acquiring one or more reliability scores corresponding to one or more reference parameters among a plurality of types of parameters related to reliability of the three-dimensional coordinates, and identification key information for specifying the one or more reliability scores corresponding to the three-dimensional coordinates, the one or more reliability scores being determined based on relationship information representing a relationship between the one or more reference parameters and the one or more reliability scores; generating a plurality of data points by integrating the three-dimensional coordinates and the one or more reliability scores based on the identification key information; and receiving the plurality of data points as input and generates visual information from the plurality of data points generated in the generating of the plurality of data points using a machine learning model that has been preliminarily trained to generate the visual information that visually represents the element according to the one or more reliability scores included in the plurality of data points.

### BRIEF DESCRIPTION OF THE DRAWINGS

The above and other objects, features and advantages of the present disclosure will become more apparent from the following detailed description made with reference to the accompanying drawings. In the drawings:

FIG. 1 is an explanatory diagram showing a schematic configuration of a drive support system according to a first embodiment;

FIG. 2 is a flowchart showing a control method for the estimation device;

FIG. 3 is a block diagram showing the relationship between components related to the estimation device of the first embodiment;

FIG. 4 is an explanatory diagram showing a schematic configuration of a drive support system according to a second embodiment;

FIG. 5 is a block diagram showing the relationship between components related to an estimation device according to a third embodiment;

FIG. 6 is an explanatory diagram showing a schematic configuration of a drive support system according to a fourth embodiment; and

FIG. 7 is a block diagram showing the relationship between components related to an estimation device according to a fourth embodiment.

### DETAILED DESCRIPTION

The VO uses the camera's internal parameters to associate the camera's coordinate system to the coordinate system of the two dimensional image. The internal parameters include, for example, the focal length and the position of the optical axis. Additionally, the VO utilizes a scale factor to convert relative position information to real-world scale. The scale factor is, for example, acceleration information acquired by an inertial sensor. Moreover, the VO uses external parameters to associate the camera's coordinate system to the external world coordinate system. The external parameters are, for example, information that indicates the rotation and parallel movement of the camera. As a result, the VO can associate the coordinate system of the two-dimensional image with the external world coordinate system, and thus can estimate three-dimensional spatial information based on the two-dimensional image.

The technique of estimating the three-dimensional spatial information using a machine learning model, as in the conceivable technique, depends on the quality of the training data and the training method. For this reason, the inventors have developed a technique for estimating three-dimensional spatial information that is more reliable than a technique that uses a machine learning model. The inventors' technique uses the VO to estimate the three-dimensional spatial information without depending on the quality of the training data or the training method.

However, compared to the technique using the LiDAR, the inventors' technique may have difficulty in acquiring highly reliable three-dimensional spatial information. Specifically, because the VO indirectly estimates the three-dimensional spatial information, it tends to use more parameters to estimate the three-dimensional spatial information than the LiDAR, which directly estimates the three-dimensional spatial information. These parameters may be subject to be affected by both internal and external factors of the camera. Therefore, if the adjustment is insufficient, the estimated three-dimensional space information may be likely to vary. As a result, the inventors' technique using the VO has difficulty in acquiring highly reliable three-dimensional spatial information compared to the technique using the LiDAR. For this reason, there is a demand for technique that can recognize the environment around the vehicle with stable accuracy.

The present disclosure can be realized as the following embodiments.

As one aspect of the present embodiments, an estimation device is provided that is mounted on a vehicle equipped with a plurality of cameras. The estimation device includes a coordinate calculation unit, an information integration unit, and a generation unit. The coordinate calculation unit calculates a group of three-dimensional coordinates representing a position of an element disposed in an environment around the vehicle using visual odometry based on a two-dimensional image acquired by at least one of the plurality of cameras. The information integration unit acquires each three-dimensional coordinate of the group of the three-dimensional coordinates. The information integration unit acquire one or more reliability scores corresponding to one or more reference parameters among a plurality of types of parameters related to reliability of each three-dimensional coordinate, and identification key information for specifying the one or more reliability scores corresponding to each three-dimensional coordinate. The one or more reliability scores are determined based on relationship information representing a relationship between the one or more reference parameters and the one or more reliability scores. The information integration unit generates a plurality of data points by integrating each three-dimensional coordinate and the one or more reliability scores based on the identification key information. The generation unit receives a plurality of data points as input and generates visual information from the plurality of data points generated by the information integration unit using a machine learning model that has been preliminarily trained to generate visual information that visually represents the element according to the one or more reliability scores included in the plurality of data points.

In such a feature, at the plurality of data points, the three-dimensional coordinates and the reliability scores corresponding to the reference parameters are associated with each other. The reference parameters relate to the reliability of the three-dimensional coordinates. The machine learning model generates the visual information by inputting the data points including the reliability scores and the three-dimensional coordinates. Therefore, the estimation device is more likely to be able to generate the visual information with stable accuracy than a feature in which the visual information is generated using the three-dimensional coordinates regardless of the reliability score.

Another aspect of the present embodiments provides a method for estimating an environment around a vehicle using a plurality of cameras. This estimation method includes: (a) a coordinate calculation step for calculating a group of three-dimensional coordinates representing a position of an element disposed in an environment around the vehicle using visual odometry based on a two-dimensional image acquired by at least one of the plurality of cameras; (b) an information integration step for acquiring each three dimensional coordinate of the group of three-dimensional coordinates, one or more reliability scores corresponding to one or more reference parameters among a plurality of types of parameters related to reliability score of each three-dimensional coordinate, and identification key information for specifying the one or more reliability scores corresponding to each three-dimensional coordinate, the one or more reliability scores being determined based on relationship information representing a relationship between the one or more reference parameters and the one or more reliability scores, and generating a plurality of data points by integrating each three-dimensional coordinate and the one or more reliability scores based on the identification key information; and (c) a generation step for receives a plurality of data points as input and generates visual information from the plurality of generated data points using a machine learning model that has been preliminarily trained to generate visual information that visually represents the element according to the one or more reliability scores included in the plurality of data points.

In such a feature, at the plurality of data points, the three-dimensional coordinates and the reliability scores corresponding to the reference parameters are associated with each other. The reference parameters relate to the reliability of the three-dimensional coordinates. The machine learning model generates the visual information by inputting the data points including the reliability scores and the three-dimensional coordinates. Therefore, the estimation method is more likely to be able to generate the visual information with stable accuracy than a feature in which the visual information is generated using the three-dimensional coordinates regardless of the reliability score.

### A. First embodiment

### A-1. System configuration:

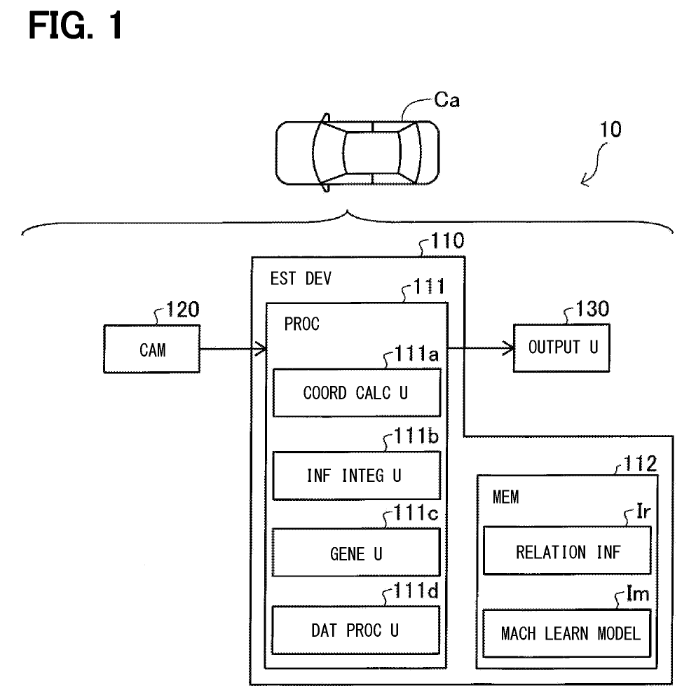

A drive support system 10 shown in FIG. 1 is mounted on and used for a vehicle Ca. The drive support system 10 estimates the environment around the vehicle Ca and provides the driver with visual information Ig that supports the driving operation. The visual information Ig is information that visually represents an element disposed in the environment around the vehicle Ca. For example, the visual information Ig is a bird's-eye view image of the vehicle Ca viewed from above.

The drive support system 10 includes an estimation device 110, a plurality of cameras 120, and an output unit 130.

The plurality of cameras 120 capture images of the surroundings of the vehicle to acquire two-dimensional images I2di. The plurality of cameras 120 include, for example, six monocular cameras. Each camera 120 captures an image of a specific area. The first camera is provided on an upper portion of the windshield of the vehicle Ca and captures an image of the area ahead of the vehicle Ca. The second and third cameras are provided on a lower portion of the right and left door mirrors, respectively, and capture images obliquely forward of the vehicle Ca. The fourth camera and the fifth camera are provided on the door pillars on the right and left sides of the vehicle Ca, and capture images of specific ranges on the right and left sides of the vehicle Ca. The sixth camera is provided in the center of the back door and captures images of the area behind the vehicle Ca.

The plurality of cameras 120 capture images of a specific range outside the vehicle Ca at a predetermined frame rate. Furthermore, each camera 120 outputs the acquired two-dimensional image I2di to the estimation device 110. To facilitate understanding of the technique, in the embodiment, it is assumed that the plurality of cameras 120 capture images at the same timing.

The estimation device 110 estimates the environment around the vehicle Ca. More specifically, the estimation device 110 uses VO (i.e., Visual Odometry) to estimate the positions of elements around the vehicle Ca based on the acquired two-dimensional image I2di. The elements disposed in the environment around the vehicle Ca include, for example, three-dimensional elements such as other vehicles, pedestrians, and utility poles, as well as two-dimensional elements such as lanes and road signs.

The VO is a method for extracting feature points from the two-dimensional image I2di and estimating the coordinates of the feature points in three-dimensional space relative to the camera 120. First, the VO detects feature points in the acquired two-dimensional image I2di. Techniques for detecting feature points include, for example, ORB (i.e., Oriented FAST and Rotated BRIEF). Here, the method for detecting feature points may also be Harris corner detection, SIFT (i.e., Scale-Invariant Feature Transform), SURF (i.e., Speed-Up Robust Features), and the like. As a result, corners and edges in the two-dimensional image I2di are detected as feature points. The detected feature points are identified to determine corresponding feature points between different frames.

The VO applies a technique, commonly defined as a projective conversion method, to associate the coordinate system of the camera 120 with the coordinate system of the two-dimensional image I2di based on the corresponding feature points. Furthermore, the VO estimates the three-dimensional positions of the feature points in the camera coordinate system by executing triangulation using the two-dimensional coordinates of the corresponding feature points. Next, the VO converts the positions of the feature points in the camera coordinate system into the world coordinate system using a rotation matrix and a translation vector that represent the orientation and position of the camera 120. More specifically, the VO sets a world coordinate system based on the camera position at a certain point in time. Furthermore, the VO estimates the trajectory of the movement of the camera 120 based on the position and orientation of the camera 120 acquired in each frame. Next, the VO constructs a three-dimensional space within the range of movement of the camera 120 by converting the positions of the feature points in each frame into a world coordinate system. That is, the coordinates of the feature points in three-dimensional space are estimated. The VO of the first embodiment further estimates the relative position of the camera 120 by adding elements of known size to the surrounding environment and using the distance between known elements as a scale factor. The scale factor may be set by using a machine learning model that inputs the two-dimensional image I2di and outputs the distance, even if there are no known elements in the surrounding environment.

The three-dimensional coordinates I3dc of the feature point are calculated based on the relative position of the camera 120 by the VO. That is, based on the two-dimensional image I2di, a point cloud representing elements disposed in the environment around the vehicle Ca is generated in the three-dimensional space. This point cloud data is used to generate visual information Ig that represents the positions of elements disposed in the environment around the vehicle Ca. The generation of the visual information Ig will be described later.

The output unit 130 outputs information according to the estimation result of the estimation device 110. The output unit 130 is, for example, a monitor provided in the vehicle Ca. That is, the output unit 130 displays a bird's-eye view image of the vehicle Ca viewed from above as the visual information Ig.

The estimation device 110 is a computer including a memory 112, an input/output interface (not shown), and a processor 111. The memory 112 and the input/output interface are connected to the processor 111 via a bus. For example, the functions of the estimation device 110 are realized by a drive control ECU (i.e., Electronic Control Unit) that controls the driving operation of the vehicle Ca.

The processor 111 is, for example, a CPU (i.e., Central Processing Unit) and a GPU (i.e., Graphics Processing Unit). The processor 111 executes programs stored in the memory 112 to realize various functions. For example, the processor 111 stores the two-dimensional images I2di received from the first to sixth cameras in the memory 112. In this embodiment, the processor 111 executes programs stored in the memory 112 to function as a coordinate calculation unit 111a, an information integration unit 111b, a generation unit 111c, and a data processing unit 111d.

Memory 112 includes, for example, RAM (i.e., Random Access Memory) and ROM (i.e., Read Only Memory). The memory 112 stores various programs and data used for various processes executed by the estimation device 110. The memory 112 includes relationship information Ir and a machine learning model Im.

The relationship information Ir represents the relationship between the reference parameter Ps and the reliability score Dc. For example, the relationship information Ir is a relational expression that represents the correlation between the reference parameter Ps and the reliability score Dc. Here, the relationship information Ir may be mapping information that associates each reference parameter Ps with its reliability score Dc.

The reference parameter Ps is one of a plurality of types of parameters related to the reliability of the three-dimensional coordinate I3dc. The three-dimensional coordinates I3dc are calculated by the VO and represent the positions of elements disposed in the environment around the vehicle Ca. This reliability means the variation in accuracy of the calculated three-dimensional coordinate I3dc. The multiple types of parameters include, for example, multiple VO parameters acquired in the VO calculation. The VO parameters include, for example, the orientation of the point cloud and the distance of the point cloud. That is, the reference parameter Ps is also one of the multiple VO parameters.

In the first embodiment, the multiple reference parameters Ps are the orientation of the point cloud and the distance of the point cloud. The orientation of the point cloud and the distance of the point cloud are acquired in the process of calculating the relative position of the camera 120 and the point cloud in the VO calculation. As described above, the three-dimensional positions of the feature points are estimated by triangulation using the two-dimensional coordinates of corresponding feature points between different frames.

Specifically, the orientation of the point cloud is the angle between a line segment parallel to the direction of travel of the camera 120 in triangulation and a line segment connecting the camera 120 and each point in the point cloud. The smaller the angle, the closer the point is to the front or rear of the vehicle Ca. The larger the angle, the closer the point is to the side between the front and rear of the vehicle Ca.

In the VO, triangulation is executed using multiple two-dimensional images I2di to determine the relative positions of the camera 120 and the feature points. The accuracy of this triangulation depends on the orientation of the feature points. Specifically, when the camera 120 captures an image while moving, the triangulation is executed using the actual positions of the feature points as the vertices and the movement distance of the camera 120 as the base of a triangle. If the feature point is close to the travel direction of the camera 120, the apex angle of the triangle becomes smaller. That is, the parallax angle becomes smaller. The smaller the parallax angle, the smaller the change in the position of the feature points between different frames.

Since the camera 120 records images in pixel units, the positions of the feature points are also expressed in pixel units. Therefore, since the amount of change in the position of the feature point is compressed to pixel units, if the feature point is close to the travel direction of the camera 120, an error may be likely to occur in the position of the feature point due to the limitation of the resolution of the camera 120. Therefore, the closer a feature point is to the travel direction of the camera 120, the lower the reliability of the three-dimensional coordinate I3dc of the feature point acquired by the VO. Similarly, if the feature point is located close to the direction opposite to the travel direction of the camera 120, the reliability of the three-dimensional coordinate I3dc decreases. That is, the reliability of the three-dimensional coordinates I3dc included in the point cloud disposed on the front side or rear side of the vehicle Ca tends to be low. On the other hand, the closer the feature point is to a direction perpendicular to the travel direction of the camera 120, the less likely an error will occur in the position of the feature point, and therefore the reliability of the three-dimensional coordinate I3dc of the feature point acquired by the VO is less likely to decrease. That is, the reliability of the three-dimensional coordinates I3dc included in the point cloud disposed on the side of the vehicle Ca tends to be high.

The distance of a point cloud is the distance from the camera 120 to the element that the point cloud represents. The greater the distance between the camera 120 and the feature point, the smaller the change in the position of the feature point in the two-dimensional image I2di before and after movement, and therefore the reliability of the three-dimensional coordinate I3dc of the feature point acquired by the VO decreases. On the other hand, the closer the distance between the camera 120 and the feature point, the greater the change in the position of the feature point, and therefore the reliability of the three-dimensional coordinates I3dc of the feature point improves.

In this way, the reference parameter Ps affects the reliability of the three-dimensional coordinate I3dc of the feature point.

The reliability score Dc is an index that indicates the degree of reliability of the three-dimensional coordinates I3dc of the feature point. The reliability score Dc varies depending on the reference parameter Ps. For example, the closer the orientation of the point cloud is to the front side or the rear side of the vehicle Ca, the greater the variation in accuracy of the three-dimensional coordinates I3dc of the feature points. Therefore, the reliability score Dc is low. The closer the orientation of the point cloud is to the side of the vehicle Ca, the smaller the variation in the three-dimensional coordinates I3dc of the feature points. Therefore, the reliability score Dc becomes high.

The aforementioned relationship information Ir is information that indicates the relationship between these reference parameters Ps and the reliability score Dc.

The machine learning model Im is trained in advance to receive a plurality of data points Idp as input and generate visual information Ig according to a plurality of reliability scores Dc included in the plurality of data points Idp. The plurality of data points Idp will be explained later. For example, when generating a bird's-eye view image from a two-dimensional image I2di using the LSS (i.e., Lift-Splat-Shoot) algorithm, the machine learning model Im generates a more accurate bird's-eye view image by using the three-dimensional coordinates I3dc of the point cloud acquired using the VO. For example, the machine learning model Im selects the three-dimensional coordinates I3dc to be used to generate the bird's-eye image based on the reliability score Dc, and thereby preferentially reflects the highly reliable three-dimensional coordinates I3dc in the bird's-eye image.

### A-2. Control method:

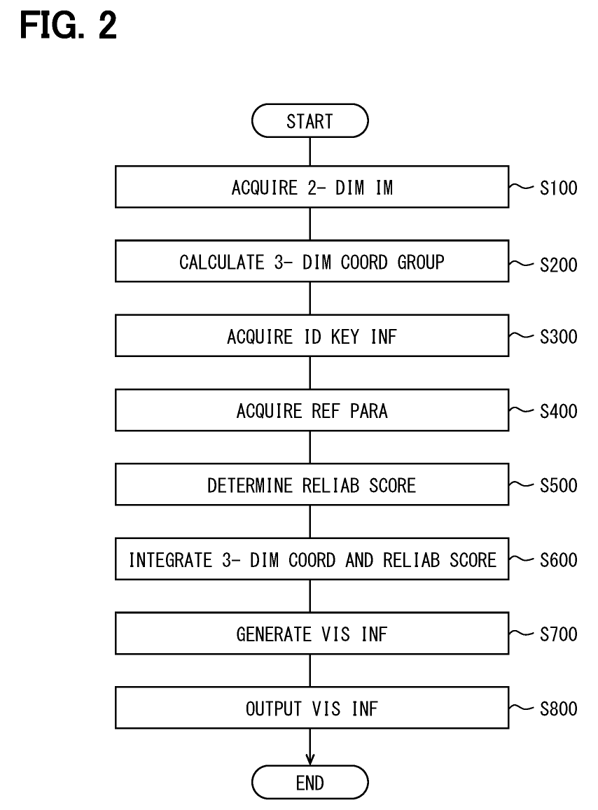

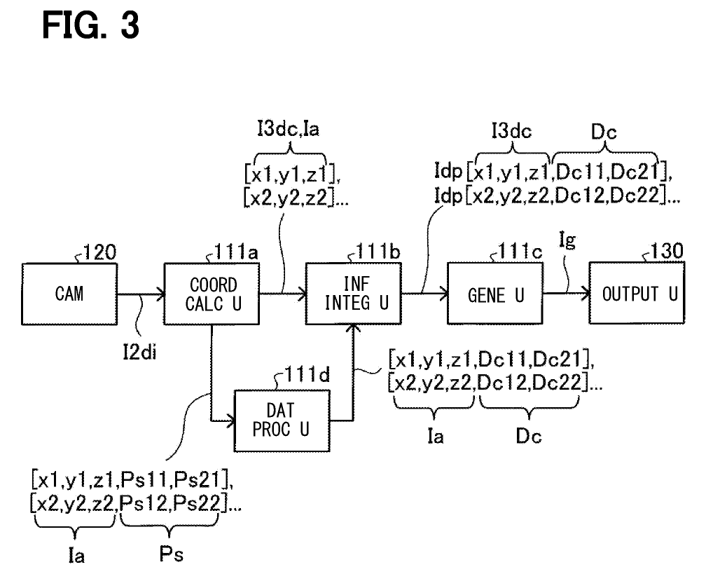

A control method for the estimation device 110 will be described with reference to FIGS. 2 and 3. In FIG. 3, x, y, and z represent three-dimensional coordinates I3dc, symbols Ps11 and Ps21 represent reference parameters Ps, and symbols Dc11 and Dc21 represent reliability score Dc. The processor 111 repeatedly executes the following processing while the estimation device 110 is in operation. That is, while the vehicle Ca is traveling, the following processing is repeatedly executed.

In step S100 of FIG. 2, the coordinate calculation unit 111a of the processor 111 acquires a plurality of two-dimensional images I2di acquired at the same time by a plurality of cameras 120 (see the middle left part of FIG. 3). That is, the processor 111 acquires a two-dimensional image I2di that captures the surroundings of the vehicle Ca.

During operation of the estimation device 110, the process of step S100 is repeatedly executed, and therefore, consecutive two-dimensional images I2di are acquired in time series by the same camera 120. In the following description, in order to facilitate understanding of the technique, it is assumed that a plurality of consecutive two-dimensional images I2di are acquired.

In step S200 of FIG. 2, the coordinate calculation unit 111a of the processor 111 uses the VO based on multiple consecutively acquired two-dimensional images I2di to calculate a group of three-dimensional coordinates representing the positions of elements disposed in the environment around the vehicle Ca (see the middle left part of FIG. 3). That is, the coordinate calculation unit 111a detects the feature points from the acquired two-dimensional image I2di. Furthermore, the coordinate calculation unit 111a estimates the three-dimensional positions of the feature points in the camera coordinate system based on the feature points that correspond between frames. Furthermore, the coordinate calculation unit 111a converts the positions of the feature points in the camera coordinate system into the world coordinate system. In this way, the coordinate calculation unit 111a calculates a group of three-dimensional coordinates that represent the positions of elements disposed in the environment around the vehicle Ca.

The processes of steps S100 and S200 are also defined as coordinate calculation processes.

In step S300 of FIG. 2, the data processing unit 111d of the processor 111 acquires the identification key information Ia corresponding to the three-dimensional coordinate I3dc from the coordinate calculation unit 111a (see the lower center part of FIG. 3). The identification key information Ia is information for identifying a plurality of reliability scores Dc corresponding to the three-dimensional coordinates I3dc. In the first embodiment, the three-dimensional coordinate I3dc is treated as the identification key information Ia.

In step S400 of FIG. 2, the data processing unit 111d of the processor 111 acquires a plurality of reference parameters Ps. More specifically, the data processing unit 111d acquires a plurality of reference parameters Ps and identification key information Ia in association with each other from the coordinate calculation unit 111a (see the lower center part of FIG. 3). That is, for each three-dimensional coordinate I3dc, the data processing unit 111d acquires the orientation of the point cloud to which the feature point represented by the three-dimensional coordinate I3dc belongs and the distance of the point cloud.

In step S500 of FIG. 2, the data processing unit 111d of the processor 111 determines a plurality of reliability scores Dc based on a plurality of reference parameters Ps and relationship information Ir. For example, the processor 111 calculates the reliability score Dc by substituting the reference parameter Ps into a relational expression that represents the correlation between the reference parameter Ps and the reliability score Dc. As a result, a reliability score Dc according to the orientation of the point cloud and a reliability score Dc according to the distance of the point cloud are acquired.

In step S600 of FIG. 2, the information integration unit 111b of the processor 111 generates a plurality of data points Idp by integrating the three-dimensional coordinates I3dc and a plurality of reliability scores Dc based on the identification key information Ia (see the middle center of FIG. 3). More specifically, the information integration unit 111b acquires, from the data processing unit 111d, the identification key information Ia and a plurality of reliability scores Dc that are associated with each other. Furthermore, the information integration unit 111b acquires, from the coordinate calculation unit 111a, the identification key information Ia determined based on the two-dimensional image I2di. In the first embodiment, the identification key information Ia is the three-dimensional coordinate I3dc. The information integration unit 111b, for example, uses the three-dimensional coordinates I3dc received from the coordinate calculation unit 111a to check the consistency of the three-dimensional coordinates I3dc received from the data processing unit 111d. Then, the information integration unit 111b treats a plurality of reliability scores Dc and the corresponding three-dimensional coordinates I3dc as one data point Idp. The process of step S600 is also defined as an information integration process.

In step S700 of FIG. 2, the generation unit 111c of the processor 111 inputs multiple data points Idp into the machine learning model Im to generate one piece of the visual information Ig representing the position of an element disposed in the surrounding environment (see the middle right part of FIG. 3). That is, the machine learning model Im generates one bird's-eye view image based on a plurality of data points Idp. At this time, the machine learning model Im selects the three-dimensional coordinates I3dc to be used to generate the bird's-eye image, for example, based on the reliability score Dc, and thereby preferentially reflects the highly reliable three-dimensional coordinates I3dc in the bird's-eye image. The process of step S700 is also defined as a generation process.

In step S800, the processor 111 outputs the visual information Ig from the output unit 130 (see the middle right part of FIG. 3). For example, the processor 111 displays a bird's-eye view image of the vehicle Ca viewed from above on the monitor. Furthermore, since the visual information Ig reflects information based on multiple images acquired by multiple cameras 120, it can represent the positions of elements disposed over a wide area in front of, behind, and to the sides of the vehicle Ca, like a bird's-eye view image.

As described above, the estimation device 110 outputs information that estimates the situation around the vehicle Ca. This provides the driver with information to support the driving operation of the vehicle Ca.

In this embodiment, the data point Idp is associated with a three-dimensional coordinate I3dc and a reliability score Dc according to the reference parameter Ps. This reference parameter Ps relates to the reliability of the three-dimensional coordinate I3dc. The machine learning model Im generates the visual information Ig when a data point Idp including a reliability score Dc and a three-dimensional coordinate I3dc is input. In other words, when the machine learning model Im generates the visual information Ig according to the reliability score Dc, there is a high possibility that the decrease in reliability of the generated visual information Ig will be suppressed. Therefore, the estimation device 110 of this embodiment is more likely to be able to generate the visual information Ig with stable accuracy than a mode in which the visual information Ig is generated using three-dimensional coordinates I3dc regardless of the reliability score Dc.

Furthermore, the reference parameter Ps is one of a plurality of VO parameters. In such an embodiment, changes in the reliability score Dc are more likely to affect the accuracy of the three-dimensional coordinate I3dc than reliability score Dc that depends on parameters unrelated to the calculation of the visual odometry. Therefore, the estimation device 110 of this embodiment may be able to generate the visual information Ig more accurately than an aspect that uses the reliability score Dc based on parameters unrelated to the calculation of visual odometry.

Furthermore, the estimation device 110 includes a data processing unit 111d. By adopting such a feature, the estimation device 110 of this embodiment can more easily determine the reliability score Dc according to the reference parameter Ps, compared to a feature in which a processing unit equivalent to the data processing unit 111d is provided externally. The reference parameter Ps may be a variety of parameters. However, since the estimation device 110 of this embodiment has an internal data processing unit 111d, it is easier to set the data processing unit 111d according to the reference parameter Ps than in a feature in which a processing unit equivalent to the data processing unit 111d is provided externally.

Furthermore, the coordinate calculation unit 111a calculates the three-dimensional coordinate I3dc using the amount of change in position and the amount of change in attitude angle of the camera 120. By adopting such a feature, the accuracy of the three-dimensional coordinate I3dc in the depth direction is improved. Since the two-dimensional image I2di does not include position information in the depth direction, the accuracy of the calculated three-dimensional coordinate I3dc in the depth direction is lower than the accuracy in the vertical and horizontal directions. However, the estimation device 110 of this embodiment can compensate for the accuracy in the depth direction that cannot be acquired from the two-dimensional image I2di by using the position and attitude angle of the camera 120 to calculate the three-dimensional coordinate I3dc. That is, the estimation device 110 of this embodiment can improve the accuracy of the three-dimensional coordinate I3dc in the depth direction.

### B. Second embodiment

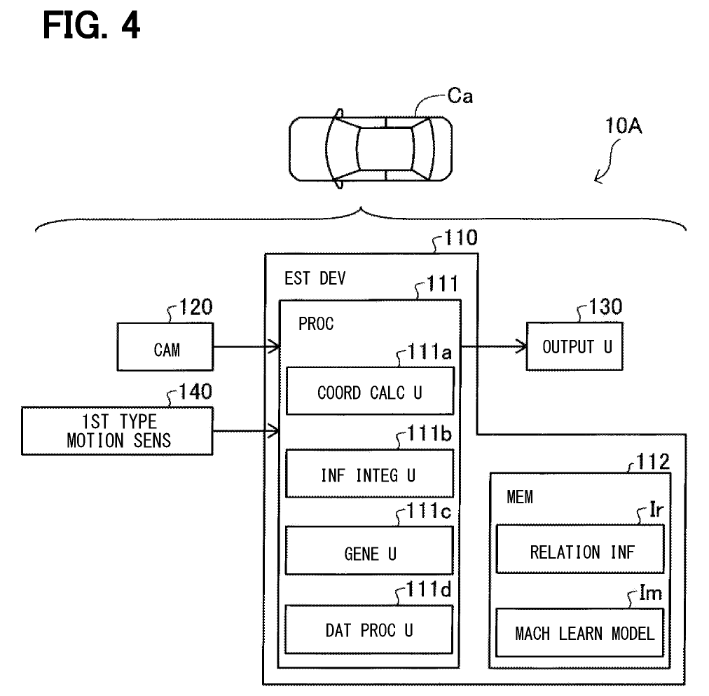

In the above embodiment, the drive support system 10 may further include a first type motion sensor 140, as in a drive support system 10A shown in FIG. 4. The same reference numerals as those in the first embodiment indicate the same configurations, and the preceding description is to be referred to.

Specifically, the first type motion sensor 140 is an inertial sensor. That is, the first type motion sensor 140 acquires the acceleration and angular velocity of the vehicle Ca. These acquired values are used to determine the amount of change in the position and the amount of change in the attitude angle of the camera 120. Based on these changes, the movement distance of the camera 120 is determined. By using the movement distance of the camera 120 in the calculation of the VO, the accuracy of the depth direction of the three-dimensional coordinate I3dc is improved.

In the method using the inertial sensor, the travel distance is calculated by double integrating the acceleration. In addition to the method using the inertial sensor, there is also a method using a wheel speed sensor mounted on the vehicle Ca. For example, the travel distance is calculated by integrating the vehicle speed, which is determined based on the wheel speed and the tire diameter. In the method using the wheel speed sensor, the accuracy of measuring the vehicle speed in the low speed range is generally lower than that in the high speed range. The wheel speed sensor normally outputs a pulse corresponding to the amount of change in magnetic flux that is generated according to the rotation of the wheel. In the low speed range, the amount of change in magnetic flux is small, and the generated pulse is therefore small. As a result, the measurement accuracy decreases. Therefore, in the method using the wheel speed sensor, errors may be likely to occur depending on the vehicle speed. However, the inertial sensor can measure the acceleration with stable accuracy regardless of the vehicle speed. Therefore, the method using the inertial sensor can calculate the travel distance of the camera 120 with stable accuracy.

The control method of the second embodiment will be described below. However, points that are not particularly described are the same as those in the first embodiment.

In step S100 of FIG. 2 in the second embodiment, the coordinate calculation unit 111a of the processor 111 acquires a plurality of two-dimensional images I2di, similarly to the first embodiment. Furthermore, the coordinate calculation unit 111a acquires the value from the first type motion sensor 140. More specifically, the coordinate calculation unit 111a acquires the acceleration and angular velocity of the vehicle Ca using an inertial sensor. As a result, an acquired value corresponding to the acquired two-dimensional image I2di is obtained. Here, as described above, during operation of the estimation device 110, the process of step S100 is repeatedly executed, and therefore, consecutive two-dimensional images I2di are acquired in time series by the same camera 120. In the description of the embodiments, in order to facilitate understanding of the technique, it is assumed that a plurality of successive two-dimensional images I2di are acquired and a plurality of values corresponding to these images are acquired.

In step S200 of FIG. 2 in the second embodiment, the coordinate calculation unit 111a of the processor 111 calculates a group of three-dimensional coordinates, similarly to the first embodiment. Her, the coordinate calculation unit 111a calculates the amount of change in the position and the amount of change in the attitude angle of the camera 120 based on the values acquired by the first type motion sensor 140. The processor 111 improves the accuracy of the three-dimensional coordinate group by using the amount of change in the attitude angle or the amount of change in the position of the camera 120 as a scale factor.

The processing of steps S300 to S800 in FIG. 2 in the second embodiment is the same as steps S300 to S800 in the first embodiment.

By adopting this configuration, the estimation device 110 of this embodiment can calculate the travel distance based on the change in position and change in attitude angle of the camera 120 with more stable accuracy than in a configuration in which a wheel speed sensor is used as the first type motion sensor 140. As a method for calculating the travel distance of the camera 120, in addition to the method using an inertial sensor, there is also a method using a wheel speed sensor mounted on the vehicle Ca. In the method using a wheel speed sensor, for example, the travel distance is calculated by integrating the vehicle speed determined based on the wheel speed and the tire diameter. In the method using the wheel speed sensor, the accuracy of measuring the vehicle speed in the low speed range is generally lower than that in the high speed range. Therefore, in the method using the wheel speed sensor, errors may be likely to occur depending on the vehicle speed. However, the inertial sensor can measure the acceleration with stable accuracy regardless of the vehicle speed. Therefore, the estimation device 110 of this embodiment can calculate the travel distance of the camera 120 with stable accuracy.

### C. Third Embodiment

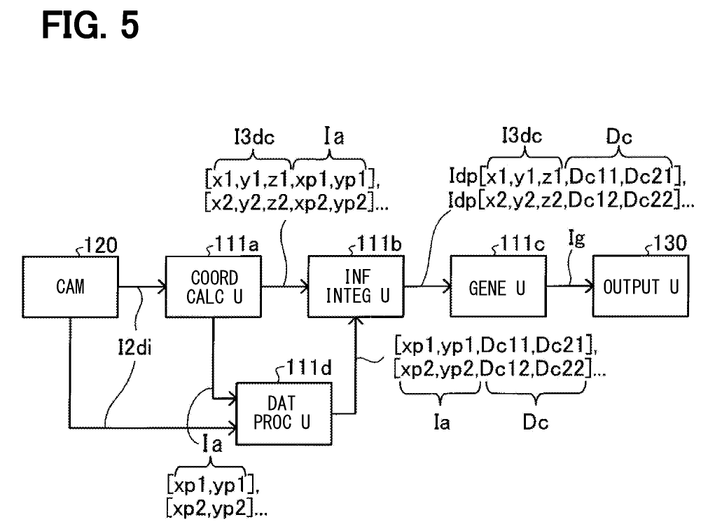

In the third embodiment shown in FIG. 5, the multiple types of parameters include multiple element parameters acquired by identifying components in the two-dimensional image I2di and associated with pixel coordinates of the two-dimensional image I2di. The element parameters are acquired by semantic segmentation, which is a type of image processing. Specifically, the element parameters are a class name that indicates the type of element on the two-dimensional image, and an ID that is assigned to each element. These parameters are explained in more detail below.

In the third embodiment, the reference parameter Ps is one of a plurality of element parameters. That is, the multiple reference parameters Ps are the class name and the ID. In the semantic segmentation, classification of IDs and class names is executed for each pixel. Therefore, a class name and an ID are associated with each pixel coordinate. Therefore, the element parameters are associated with pixel coordinates of the two-dimensional image I2di.

The control method of the third embodiment will be described below. The same reference numerals as those in the first embodiment indicate the same configurations, and the preceding description is to be referred to. Features not specifically described are the same as those in the first embodiment.

Steps S100 and S200 in FIG. 2 in the third embodiment are the same as those in the first embodiment.

In step S300 of FIG. 2 in the third embodiment, the data processing unit 111d of the processor 111 acquires the identification key information Ia corresponding to the three-dimensional coordinate I3dc from the coordinate calculation unit 111a (see the lower middle part of FIG. 5). The identification key information Ia is the pixel coordinates of the two-dimensional image I2di used to calculate the three-dimensional coordinates I3dc.

In step S400 of FIG. 2 in the third embodiment, the data processing unit 111d of the processor 111 acquires a plurality of reference parameters Ps. More specifically, the data processing unit 111d of the processor 111 generates a plurality of reference parameters Ps in association with pixel coordinates based on the two-dimensional image I2di, thereby acquiring a plurality of reference parameters Ps. That is, the data processing unit 111d first acquires from the camera 120 the two-dimensional image I2di acquired by the coordinate calculation unit 111a in step S100. Furthermore, the data processing unit 111d uses the semantic segmentation to assign an ID to each element in the two-dimensional image I2di and to assign a class name to each type of element. In this way, a plurality of reference parameters Ps associated with pixel coordinates are generated.

These reference parameters Ps affect the reliability of the three-dimensional coordinate I3dc.

The class names are assigned not only to three-dimensional elements such as a vehicle Ca and a person, but also to two-dimensional elements such as the ground and a wall. For example, feature point detection may tend to be unstable on ground or walls with poor texture. That is, the reliability of the three-dimensional coordinate I3dc based on the feature point may tend to be low. Furthermore, it may be difficult to associate feature points between different frames for point clouds that belong to moving elements. For this reason, the reliability of the three-dimensional coordinates I3dc included in the point group belonging to such an element may tend to be low. On the other hand, the reliability of the three-dimensional coordinates I3dc included in the point cloud belonging to an element having a portion where feature points are easily detected, such as a corner and an edge, or a static element, may tend to be high.

An ID is assigned to each element regardless of the type of element. The point group having the same ID is usually disposed within or around the area occupied by the element in three-dimensional space. Therefore, if a part of the point cloud is disposed at a position that is significantly far, there is a high possibility that an incorrect feature point has been detected. That is, the reliability of the three-dimensional coordinates I3dc included in such a point group may tend to be low. For example, if the class name is "car" and the distance between point clouds with the same ID is far enough away from each other than the size of a typical vehicle, the reliability of the three-dimensional coordinates I3dc included in that point cloud is expected to be low. On the other hand, if the point cloud is disposed within the proper position, it is highly likely that the feature points have been detected correctly. That is, the reliability of the three-dimensional coordinates I3dc included in such a point group may tend to be high. For example, if the class name is “car” and the distance between point clouds with the same ID is within the range of a typical vehicle, the reliability of the three-dimensional coordinates I3dc included in the point cloud is expected to be high.

When such a reference parameter Ps is set, the relationship information Ir is, for example, mapping information between a class name and a reliability score Dc, and between an ID and a reliability score Dc.

For the three-dimensional coordinates I3dc relating to an element to which an ID or a class name cannot be assigned, for example, a predetermined reliability score Dc is set.

In step S500 of FIG. 2 in the third embodiment, the data processing unit 111d of the processor 111 determines a plurality of reliability scores Dc based on a plurality of reference parameters Ps and relationship information Ir. That is, the data processing unit 111d uses a plurality of reference parameters Ps and refers to the relationship information Ir to acquire a plurality of reliability scores Dc.

In step S600 of FIG. 2 in the third embodiment, the information integration unit 111b of the processor 111 generates a data point Idp by integrating the three-dimensional coordinates I3dc and a plurality of reliability scores Dc based on the identification key information Ia (see the middle center of FIG. 5). More specifically, the information integration unit 111b acquires, from the data processing unit 111d, the identification key information Ia and a plurality of reliability scores Dc that are associated with each other. Furthermore, the information integration unit 111b acquires the three-dimensional coordinates I3dc and the identification key information Ia determined based on the two-dimensional image I2di from the coordinate calculation unit 111a. In the third embodiment, the identification key information Ia is pixel coordinates. That is, the information integration unit 111b acquires the three-dimensional coordinates I3dc and pixel coordinates from the coordinate calculation unit 111a, and acquires the pixel coordinates and a plurality of reliability scores Dc from the data processing unit 111d. The information integration unit 111b, for example, uses the pixel coordinates received from the coordinate calculation unit 111a to check the consistency of the pixel coordinates received from the data processing unit 111d. Then, the information integration unit 111b treats a plurality of reliability scores Dc and the corresponding three-dimensional coordinates I3dc as one data point Idp.

Steps S700 and S800 in FIG. 2 in the third embodiment are the same as those in the first embodiment.

In this embodiment, the reference parameter Ps is one of the element parameters that identify the components in the two-dimensional image I2di. The estimation device 110 of this embodiment determines the reliability score Dc according to the parameters. The element parameters are, for example, a class indicating the type of element acquired by the semantic segmentation, which is a type of image processing, or an ID assigned to each element. That is, the reliability score Dc is likely to differ for each component element in the two-dimensional image I2di. Therefore, the estimation device 110 of this embodiment may be able to more accurately estimate elements disposed in the surrounding environment based on the component elements in the two-dimensional image I2di than a feature that uses a reliability score Dc based on parameters other than element parameters.

### D. Fourth Embodiment

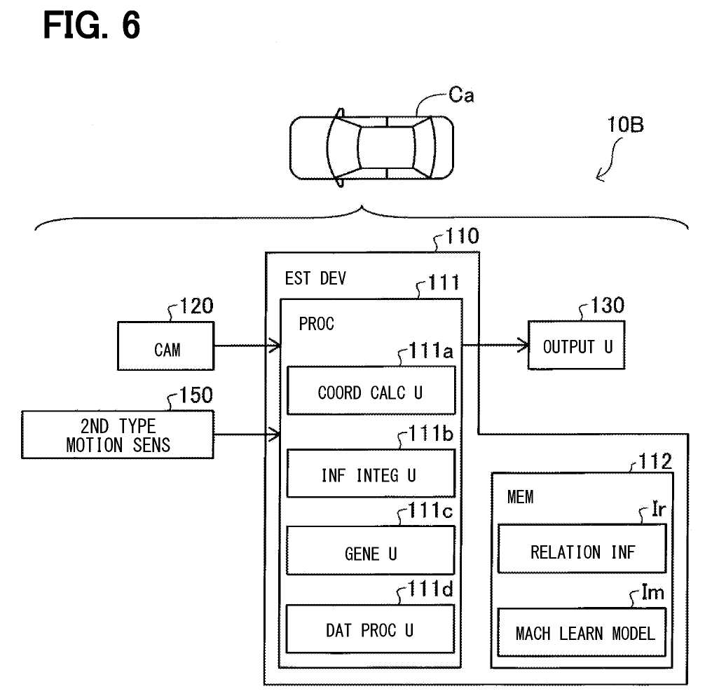

In the fourth embodiment of the drive support system 10B shown in FIG. 6, the vehicle Ca further includes a second type motion sensor 150 including one sensor that measures one motion parameter that represents the travelling state of the vehicle Ca. The second type motion sensor 150 is, for example, a wheel speed sensor. The second type motion sensor 150 acquires the vehicle speed as a motion parameter based on the wheel speed. More specifically, the second type motion sensor 150 acquires the vehicle speed by calculating the vehicle speed based on the wheel speed and the tire diameter. The second type motion sensor 150 may be an inertial sensor. That is, the second type motion sensor 150 may be configured by the first type motion sensor 140 of the second embodiment. If the second type motion sensor 150 is an inertial sensor, the vehicle speed may be acquired by integrating the acceleration.

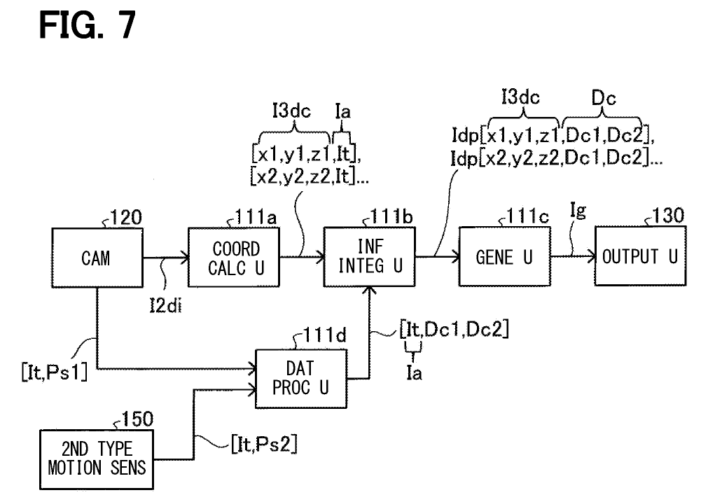

As shown in FIG. 7, in the fourth embodiment, the multiple types of parameters include motion parameters acquired by the second type motion sensor 150 and internal parameters of the camera 120. An internal parameter of the camera 120 is, for example, the exposure time.

In the fourth embodiment, the reference parameter Ps is one of a motion parameter and an internal parameter of the camera 120. That is, the multiple reference parameters Ps are the vehicle speed and the exposure time. In FIG. 7, Ps1 denotes an internal parameter of the camera 120, Dc1 denotes a reliability score Dc according to the internal parameter of the camera 120, Ps2 denotes a motion parameter, and Dc2 denotes a reliability score Dc according to the motion parameter.

The control method of the fourth embodiment will be described below. The same reference numerals as those in the first embodiment indicate the same configurations, and the preceding description is to be referred to. Features not specifically described are the same as those in the first embodiment.

Steps S100 and S200 in FIG. 2 in the fourth embodiment are the same as those in the first embodiment.

In step S300 of FIG. 2 in the fourth embodiment, the data processing unit 111d of the processor 111 acquires the time It when the motion parameters are acquired from the second type motion sensor 150 and the time It when the internal parameters of the camera 120 are acquired from the camera 120 (see the lower middle section of FIG. 7). These acquisition times It are later treated as the identification key information Ia. Although these acquisition times It are determined by first acquiring parameters, they will be described together with the explanations of other embodiments to facilitate understanding of the technique.

The time It when the internal parameters of the camera 120 are acquired is the same as the time It when the two-dimensional image I2di is acquired in step S100. The time It for acquiring the motion parameters is adjusted to match the timing closest to the time It for acquiring the internal parameters of the camera 120. Therefore, the time It when the motion parameters are acquired is close to the time It when the internal parameters of the camera 120 are acquired.

In step S400 of FIG. 2 in the fourth embodiment, the data processing unit 111d of the processor 111 acquires a plurality of reference parameters Ps from the second type motion sensor 150 and the camera 120. The data processing unit 111d acquires from the camera 120 the internal parameters of the camera 120 related to the two-dimensional image I2di acquired in step S100. Furthermore, the data processing unit 111d acquires the motion parameters from the second type motion sensor 150 at the timing closest to the acquisition time It of the two-dimensional image I2di acquired in step S100. In this way, the data processing unit 111d acquires a plurality of reference parameters Ps and the identification key information Ia in association with each other.

In the fourth embodiment, the plurality of reference parameters Ps are wheel speed and exposure time. These affect the reliability of the three-dimensional coordinate I3dc.

The vehicle speed represents the travelling speed of the camera 120 provided on the vehicle Ca. When the vehicle speed is low, the parallax angle between different frames becomes small in the triangulation when calculating the three-dimensional coordinate I3dc. This reduces the reliability of the three-dimensional coordinates I3dc included in the point cloud. On the other hand, when the vehicle speed is high, the parallax angle between different frames increases in the triangulation when calculating the three-dimensional coordinate I3dc. Therefore, the reliability of the three-dimensional coordinates I3dc included in the point cloud is less likely to decrease.

For example, the exposure time is set long in a dark place, and therefore blurring of the two-dimensional image I2di may be likely to occur. That is, it becomes difficult to detect and track feature points. This reduces the reliability of the three-dimensional coordinates I3dc included in the point cloud. On the other hand, since the exposure time is set to be short in a bright place, for example, the two-dimensional image I2di is less likely to be blurred due to the movement of the camera 120. That is, the feature points can be easily detected and tracked. Therefore, the reliability of the three-dimensional coordinates I3dc included in the point cloud is less likely to decrease.

When such a reference parameter Ps is set, the relationship information Ir is, for example, a relational expression that represents the correlation between the wheel speed or exposure time and the reliability score Dc.

In step S500 of FIG. 2 in the fourth embodiment, the data processing unit 111d of the processor 111 determines a plurality of reliability scores Dc based on a plurality of reference parameters Ps and relationship information Ir. That is, a reliability score Dc according to the vehicle speed and a reliability score Dc according to the exposure time are acquired for each acquisition time It. The data processing unit 111d associates the acquisition time It of the internal parameters of the camera 120 with the reliability score Dc among the acquisition time It of the motion parameters and the acquisition time It of the internal parameters of the camera 120, and transmits them to the information integration unit 111b. Here, the data processing unit 111d may associate the motion parameter acquisition time It with the reliability score Dc.

In step S600 of FIG. 2 in the fourth embodiment, the information integration unit 111b of the processor 111 generates a data point Idp by integrating the three-dimensional coordinates I3dc and a plurality of reliability scores Dc based on the identification key information Ia (see the middle center of FIG. 7). More specifically, the information integration unit 111b acquires, from the data processing unit 111d, the identification key information Ia and a plurality of reliability scores Dc that are associated with each other. Furthermore, the information integration unit 111b acquires the three-dimensional coordinates I3dc and the identification key information Ia determined based on the two-dimensional image I2di from the coordinate calculation unit 111a.

That is, the information integration unit 111b acquires the acquisition time It of the internal parameters of the camera 120 and a plurality of reliability scores Dc from the data processing unit 111d. Furthermore, the information integration unit 111b acquires the three-dimensional coordinates I3dc and the acquisition time It of the two-dimensional image I2di from the coordinate calculation unit 111a. The information integration unit 111b, for example, uses the acquisition time It received from the coordinate calculation unit 111a to check the consistency of the acquisition time It received from the data processing unit 111d. Then, the information integration unit 111b treats a plurality of reliability scores Dc and the corresponding three-dimensional coordinates I3dc as one data point Idp.

Steps S700 and S800 in FIG. 2 in the fourth embodiment are the same as those in the first embodiment.

In this embodiment, the reference parameter Ps is one of a motion parameter and an internal parameter of the camera 120. The quality of the two-dimensional image I2di may deteriorate depending on the capturing conditions of the camera 120. Therefore, the estimation device 110 of this embodiment may be able to suppress deterioration in the quality of the visual information Ig depending on the quality of the two-dimensional image I2di.

### E. Fifth Embodiment

In the first embodiment, the multiple VO parameters are the orientation of the point cloud and the distance of the point cloud. Here, the plurality of VO parameters may include other parameters acquired in the calculation of the VO. That is, the reference parameter Ps may be any of the other parameters exemplified below. The processing executed in the following examples is executed by the data processing unit 111d.

(E1) The multiple VO parameters may be distance errors between feature points detected on the two-dimensional image I2di and the reprojected point cloud. This parameter is acquired by calculating the difference between the position coordinates of the feature points and the position coordinates of the point cloud re-projected based on the position coordinates of the feature points on the camera image and the position coordinates of the point cloud re-projected onto the camera image. The larger this error, the lower the reliability of the three-dimensional coordinate I3dc. On the other hand, the smaller this error is, the less likely the reliability of the three-dimensional coordinate I3dc is to decrease.

(E2) The multiple VO parameters may include residual errors of the camera 120. The residual error of the camera 120 is the sum or average of the above distance errors. Methods for calculating the residual error of camera 120 include, for example, squared error (i.e., SE), mean squared error (i.e., MSE), root mean squared error (i.e., RMSE), absolute error (i.e., AE), and mean absolute error (i.e., MAE). The larger the residual error of the camera 120, the lower the reliability of the three-dimensional coordinate I3dc. On the other hand, the smaller the residual error of the camera 120, the less likely the reliability of the three-dimensional coordinate I3dc is to decrease.

(E3) The plurality of VO parameters may include residual errors used in the optimization calculation. This optimization calculation is executed with the purpose of minimizing the error between the observation values of feature points detected in the current two-dimensional image I2di and the estimation values of feature points calculated from past feature points and changes in camera posture, and the like in order to accurately estimate the movement of the camera 120. In particular, optimization calculations are executed using Visual Inertial Odometry, which uses an inertial sensor to calculate the VO, Visual Wheel Odometry, which uses a wheel speed sensor, and Visual Inertial Wheel Odometry, which uses both of the inertial sensor and the wheel speed sensor. The residual used in the optimization calculation represents the difference between the estimation value and the observation value, and the larger the error, the lower the reliability of the three-dimensional coordinate I3dc. On the other hand, the smaller this error is, the less likely the reliability of the three-dimensional coordinate I3dc is to decrease.

(E4) The plurality of VO parameters may include feature point scores. The feature point score is an index that evaluates how useful each pixel in the two-dimensional image I2di is as a feature point. In the VO, the accuracy of tracking the feature points affects the accuracy of estimating the three-dimensional positions, so it may be preferable that the feature points have characteristics that make tracking errors less likely. In the good Features To Track algorithm, the ease of tracking the feature points is evaluated using a feature point score. Pixels with a score equal to or greater than the threshold are treated as the feature points. A feature point with a low feature point score is likely to be tracked incorrectly, and therefore the reliability of the three-dimensional coordinate I3dc may tend to be low. A feature point with a high feature point score is less likely to be tracked incorrectly, and therefore the three-dimensional coordinate I3dc may tend to be highly reliable.

(E5) The multiple VO parameters may include a result of whether or not there is a deviation from the epipolar line of the optical flow. The optical flow is used to estimate the movement of the camera 120 and the motion of the elements being captured. The optical flow represents the movement of feature points between successive image frames as two-dimensional vectors. That is, the optical flow indicates the direction and magnitude of movement of a feature point between previous and next frames. The optical flow is acquired by, for example, the Lucas-Kanade method. The epipolar line is a line that indicates the trajectory along which the feature points may be disposed in the next frame.

The deviation of the optical flow from the epipolar line is calculated based on the optical flow and the camera image. In a specific method (e.g., "Optimal Computation of the Optical Flow Fundamental Matrix and Its Reliability Evaluation", Shimizu Yoshiyuki, and Kanaya Kenichi, Department of Information Engineering, Faculty of Engineering, Gunma University, (online, searched February 19, 2025, Internet URL: https:// iim.cs.tut.ac.jp/ member/ kanatani/ papers/ flowmatrix.pdf), an epipolar line is calculated from the two-dimensional image I2di, and the deviation of the optical flow from the epipolar line is calculated. Here, the document of "Optimal Calculation of Optical Flow Fundamental Matrix and Its Reliability Evaluation" is incorporate herein by reference. If the optical flow of a feature point deviates from the epipolar line, the feature point is either detected from a moving object or has been mistracked. In either case, the reliability of the three-dimensional coordinate I3dc decreases. On the other hand, if the optical flow of a feature point matches the epipolar line, the feature point is detected from a stationary element or is properly tracked. In any case, the reliability of the three-dimensional coordinate I3dc is unlikely to decrease.

(E6) The plurality of VO parameters may include the number of optimization calculations of the point cloud. The more times the optimization calculation is executed, the higher the accuracy of the three-dimensional coordinates I3dc included in the point cloud tends to be. On the other hand, the fewer the number of optimization calculations, the lower the accuracy of the three-dimensional coordinates I3dc included in the point cloud tends to be.

(E7) The multiple VO parameters may include the standard deviation or variance of depth estimation values of the same point cloud across multiple frames. The depth estimation value is a value that indicates the distance from the camera 120 to the observed feature point. The standard deviation or variance of the depth estimation values is determined based on the depth estimation values of the point cloud by calculating the standard deviation or variance. If the standard deviation or variance of the depth estimation values does not converge, it is possible that feature points are not being detected properly, the VO calculations are not being executed properly or the like. That is, the reliability of the three-dimensional coordinates I3dc included in a point cloud where the standard deviation or variance of the depth estimation values does not converge may tend to be low. On the other hand, the reliability of the three-dimensional coordinates I3dc included in the point cloud to which the standard deviation or variance of the depth estimation values converges may tend to be high.

(E8) The plurality of VO parameters may include pixel values. The pixel value is determined based on the two-dimensional image I2di and the position of the feature point on the two-dimensional image I2di by referencing the brightness value at the position of the feature point in the two-dimensional image I2di. The reliability of the three-dimensional coordinate I3dc based on the feature point where the pixel value is the upper limit value at which whiteout occurs or the lower limit value at which blackout occurs may tend to be low. On the other hand, the reliability of the three-dimensional coordinates I3dc based on the feature point whose pixel values are properly maintained may tend to be high.

(E9) The plurality of VO parameters may include a change in brightness value of a feature point detected by the tracking. This amount of change is determined by calculating the difference in brightness values acquired by referring to the brightness values of the feature point positions in the two-dimensional image I2di before and after tracking, based on the two-dimensional image I2di and the feature point positions on the two-dimensional image I2di before and after tracking. If the brightness values are significantly different, there is a possibility that the tracking of the feature points may be failed. That is, the reliability of the three-dimensional coordinate I3dc may tend to be low. On the other hand, if the brightness values are uniform, there is a high probability that the feature points have been successfully tracked. That is, the reliability of the three-dimensional coordinate I3dc may tend to be high.

### F. Sixth Embodiment

In the third embodiment, the element parameters are a class name and an ID. Here, the element parameter may be any other parameter. For example, the element parameters may be parameters that are calculated based on the ID. Specifically, the parameters calculated based on the IDs represent the degree of distribution of point groups belonging to the same ID. For example, this is the standard deviation. Here, the degree of distribution of point clouds belonging to the same ID may be the density of point clouds belonging to the same ID. In such a case, the relationship information Ir is, for example, a relational expression that represents the correlation between the degree of distribution of point groups belonging to the same ID and the reliability score Dc. That is, the relationship information Ir of the parameter calculated based on the ID is a relational expression that represents the correlation between the standard deviation and the reliability score Dc. The parameters calculated based on the ID are acquired by the data processing unit 111d.

### G. Seventh Embodiment

In the fourth embodiment, the motion parameter is the vehicle speed, and the internal parameter of the camera 120 is the exposure time. Here, each of the motion parameters and the internal parameters of the camera 120 may be other parameters. That is, the reference parameter Ps may be any of the other parameters exemplified below. First, examples of motion parameters will be described. The processing executed in the following examples is executed by the data processing unit 111d.

(G1) The motion parameter may be the effective value of acceleration or the maximum and minimum peak-to-peak value of acceleration. In this case, the second type motion sensor 150 is an inertial sensor provided in the vehicle Ca. These values are based on the acceleration acquired by the inertial sensors. In a specific method (e.g., "Measurement Column for emm No. 176", Ono Sokki Co., Ltd., (online, searched February 19, 2025, Internet URL: https:// www.onosokki.co.jp/ HP-WK/ eMM_back/ emm176.pdf), these values are calculated by acquiring the effective value or maximum and minimum peak-to-peak value of acceleration, which represents the strength of vibration from the acceleration acquired by the inertial sensor mounted on the vehicle Ca. When the two-dimensional image I2di is blurred due to the vibration of the vehicle Ca, the tracking of feature points may be likely to be erroneous. That is, the reliability of the three-dimensional coordinate I3dc decreases. On the other hand, when the vehicle Ca is in a stable state and no blurring occurs in the two-dimensional image I2di, the feature points are accurately tracked. That is, the reliability of the three-dimensional coordinate I3dc is unlikely to decrease.

(G2) The motion parameter may be angular velocity. In this case, the second type motion sensor 150 is an inertial sensor provided in the vehicle Ca. When the vehicle Ca makes a sharp turn and the two-dimensional image I2di is blurred, it becomes easier to make errors in tracking the feature points. That is, the reliability of the three-dimensional coordinates I3dc of the point cloud decreases. On the other hand, when the vehicle Ca is in a stable state and no blurring occurs in the two-dimensional image I2di, the feature points are accurately tracked. That is, the reliability of the three-dimensional coordinate I3dc is unlikely to decrease.

Next, the internal parameters of the camera 120 will be described.

(G3) The internal parameter of the camera 120 may be a gain. When the gain is set to a large value in a dark place, random noise for each pixel of the two-dimensional image I2di increases. In tracking the feature points, the identity of the feature points is evaluated based on the values of pixels around the feature points. Therefore, the tracking may be likely to have errors when the random noise increases. That is, the reliability of the three-dimensional coordinate I3dc decreases. On the other hand, the reduction of random noise leads to more accurate tracking. That is, the reliability of the three-dimensional coordinate I3dc is less likely to decrease.

(G4) The internal parameter of the camera 120 may be the aperture F-number. In a dark place, if the aperture F-number of the camera 120 is set small due to the large aperture of the camera 120, the subject of the camera 120 will be blurred at the periphery of the two-dimensional image I2di. The feature points detected from the blurred two-dimensional image I2di may be likely to have error in the tracking. That is, the reliability of the three-dimensional coordinates I3dc of the point cloud decreases. On the other hand, feature points detected from the clear two-dimensional image I2di can be accurately tracked. In other words, the reliability of the three-dimensional coordinates I3dc of the point cloud is less likely to decrease.

### H. Eighth embodiment

In the above embodiment, the first type motion sensor 140 is an inertial sensor. Here, the first type motion sensor 140 may be a wheel speed sensor provided on each wheel of the vehicle Ca. That is, the first type motion sensor 140 acquires the wheel speed of each wheel. The wheel speed is used to determine the amount of change in the position and the amount of change in the attitude angle of the camera 120. Specifically, the amount of change in the position of the camera 120 is calculated based on the wheel speed and the tire diameter. The attitude angle of the camera 120 is calculated by determining the angle when the vehicle Ca is turning using the difference between the left and right wheel speeds. Based on these changes, the movement distance of the camera 120 is determined.

By adopting such a feature, the estimation device 110 of this embodiment may be able to reduce errors that occur in calculating the travel distance of the camera 120 compared to a feature in which an inertial sensor is used as the first type motion sensor 140. In the method using the wheel speed sensor, the travel distance of the camera 120 is calculated by integrating the vehicle speed. On the other hand, in the method using the inertial sensor, the travel distance of the camera 120 is calculated by double integrating the acceleration. For this reason, errors included in the values acquired by the sensors may also tend to accumulate. Therefore, the estimation device 110 of this embodiment can reduce errors that occur in calculating the travel distance of the camera 120 compared to a feature that uses an inertial sensor.

### I. Ninth Embodiment

In the above embodiment, the first type motion sensor 140 may include both a wheel speed sensor and an inertial sensor. By adopting such an embodiment, the estimation device 110 of this embodiment can calculate the travel distance of the camera 120 more accurately than in a feature in which the travel distance of the camera 120 is calculated based on the value acquired by one sensor.

### E. Other Embodiments

(J1) In the above embodiment, the machine learning model Im receives the point cloud data as input and generates a bird's-eye view image. Alternatively, the machine learning model Im may generate other visual information Ig. For example, the machine learning model Im may be configured as a three-dimensional convolutional neural network. That is, the machine learning model Im may generate a three-dimensional image drawn in a stereoscopic manner using the point cloud data as input. The machine learning model Im selects three-dimensional coordinates I3dc to be used for generating three-dimensional data based on the reliability score Dc, and thereby preferentially reflects highly reliable three-dimensional coordinates I3dc in the three-dimensional image.

(J2) In the above embodiment, the generation unit 111c generates one piece of the visual information Ig based on a plurality of data points Idp. Alternatively, the generation unit 111c may generate one or more pieces of the visual information Ig based on a plurality of data points Idp. That is, the generation unit 111c may generate both a bird's-eye view image and a three-dimensional image.

(J3) In the above embodiment, the drive support system 10 includes multiple cameras 120. Alternatively, the number of cameras 120 provided in the drive support system 10 may be one.

(J4) In the above embodiment, the two-dimensional images I2di acquired by the multiple cameras 120 are used to calculate the three-dimensional coordinate group. That is, all of the two-dimensional images I2di acquired by the multiple cameras 120 are used to calculate the three-dimensional coordinate group. Alternatively, the two-dimensional image I2di used to calculate the three-dimensional coordinate group may be acquired by at least one of the multiple cameras 120.

(J5) In the above embodiment, a plurality of consecutively acquired two-dimensional images I2di are used to calculate a group of three-dimensional coordinates. Alternatively, the multiple two-dimensional images I2di to be used to calculate the three-dimensional coordinate group do not necessarily have to be acquired consecutively.

(J6) In the above embodiment, a plurality of reference parameters Ps and a plurality of reliability scores Dc are used. Alternatively, a single reference parameter Ps and a single reliability score Dc may be used. For example, in the fourth embodiment, the vehicle speed and the exposure time are used as the reference parameter Ps, but only one of them may be used. That is, it is sufficient that one or more reference parameters Ps and one or more reliability scores Dc are used.

Similarly, in the above embodiment, a data point Idp is configured by combining one three-dimensional coordinate I3dc and a plurality of reliability scores Dc. Alternatively, a data point Idp may be configured by combining one three-dimensional coordinate I3dc and one reliability score Dc.

(J7) In the above embodiment, the vehicle Ca is equipped with a second type motion sensor 150 including one sensor that measures one motion parameter that represents the travelling state of the vehicle Ca. Alternatively, there may be multiple motion parameters. Furthermore, multiple sensors may be used.

(J8) In the above embodiment, the first type motion sensor 140 and the second type motion sensor 150 may be configured as the same sensor.

(J9) In the above embodiment, the estimation device 110 includes a data processing unit 111d. Alternatively, the estimation device 110 does not necessarily have to include the data processing unit 111d. For example, the estimation device 110 may receive the identification key information Ia and one or more reliability scores Dc from an external control device.

(J10) In the above embodiment, the multiple types of parameters are any of multiple VO parameters, multiple element parameters, motion parameters, and internal parameters of the camera 120. Alternatively, the multiple types of parameters may include two or more of these. Here, the motion parameters and the internal parameters of the camera 120 do not necessarily have to be a set thereof. Furthermore, the multiple types of parameters may include other parameters related to the reliability of the three-dimensional coordinate I3dc in addition to the parameters described above.

That is, the reference parameters Ps may also include at least one parameter selected from a plurality of VO parameters, a plurality of element parameters, a motion parameter, and an internal parameter of the camera 120. Furthermore, the reference parameter Ps may be another parameter related to the reliability of the three-dimensional coordinate I3dc.

(J11) In the above embodiment, the estimation device 110 includes a machine learning model Im. The estimation device 110 does not need to be equipped with the machine learning model Im. For example, the estimation device 110 may use a machine learning model Im provided in a device external to the vehicle Ca via wireless communication.

(J12) The estimation device 110 and the estimation method described in the present embodiments may be implemented by a dedicated computer provided by configuring a processor and memory programmed to perform one or more functions embodied in a computer program. Alternatively, the control unit and the like and the method thereof described in the present embodiments may be achieved by a dedicated computer provided by configuring a processor with one or more dedicated hardware logic circuits. Alternatively, the control unit and the like and the method thereof described in the present embodiments may be achieved by one or more dedicated computers configured by a integration of a processor and a memory programmed to execute one or more functions and a processor configured by one or more hardware logic circuits. The computer program may also be stored on a computer-readable and non-transitory tangible storage medium as an instruction executed by a computer.

The present disclosure should not be limited to the embodiments or modifications described above, and various other embodiments may be implemented without departing from the scope of the present disclosure. For example, the technical features in each embodiment corresponding to the technical features in the form described in the summary may be used to solve some or all of the above-described problems, or to provide one of the above-described effects. In order to achieve a part or all, replacement or integration can be appropriately performed. Also, some of the technical features may be omitted as appropriate.

### K. Other Features

Features of the present embodiments will be described below.

### Feature 1

An estimation device is mounted on a vehicle equipped with a plurality of cameras. The estimation device includes a coordinate calculation unit, an information integration unit, and a generation unit. The coordinate calculation unit calculates a group of three-dimensional coordinates representing a position of an element disposed in an environment around the vehicle using visual odometry based on a two-dimensional image acquired by at least one of the plurality of cameras. The information integration unit acquires each three-dimensional coordinate of the group of the three-dimensional coordinates. The information integration unit acquires one or more reliability scores corresponding to one or more reference parameters among a plurality of types of parameters related to reliability of the three-dimensional coordinates, and identification key information for specifying the one or more reliability scores corresponding to each three-dimensional coordinate. The one or more reliability scores are determined based on relationship information representing a relationship between the one or more reference parameters and the one or more reliability scores. The information integration unit generates a plurality of data points by integrating each three-dimensional coordinate and the one or more reliability scores based on the identification key information. The generation unit receives the plurality of data points as input and generates visual information from the plurality of data points generated by the information integration unit using a machine learning model that has been preliminarily trained to generate the visual information that visually represents the element according to the one or more reliability scores included in the plurality of data points.

### Feature 2

The estimation device according to feature 1, further includes: a data processing unit. The data processing unit is configured to: acquire the one or more reference parameters; determine the one or more reliability scores based on the one or more reference parameters and the relationship information; and acquire the identification key information corresponding to the three-dimensional coordinates. The information integration unit acquires the identification key information corresponding to the three-dimensional coordinates and the one or more reliability scores from the data processing unit, and acquires the identification key information determined based on the two-dimensional image by the coordinate calculation unit.

### Feature 3

In the estimation device according to feature 3, the vehicle further includes a first type motion sensor including at least one of an inertial sensor and a wheel speed sensor. The coordinate calculation unit further calculates the three-dimensional coordinates using a change in position and a change in attitude angle of the at least one of the plurality of cameras acquired based on a plurality of acquired values of the first type motion sensor.

### Feature 4

In the estimation device according to feature 3, the first type motion sensor does not include the wheel speed sensor but includes the inertial sensor.

### Feature 5

In the estimation device according to feature 3, the first type motion sensor does not include the inertial sensor but includes the wheel speed sensor.

### Feature 6

In the estimation device according to feature 3, the first type motion sensor includes both the wheel speed sensor and the inertial sensor.

### Feature 7

In the estimation device according to any one of features 2 to 6, the plurality of types of parameters include a plurality of VO (Visual Odometry) parameters acquired in calculation of the group of three-dimensional coordinates using the visual odometry. The identification key information is the three-dimensional coordinates. The data processing unit acquires the one or more reference parameters and the identification key information in association with each other from the coordinate calculation unit.

### Feature 8

In the estimation device according to any one of features 2 to 6, the plurality of types of parameters include a plurality of element parameters acquired by identifying a component element in the two-dimensional image and associated with pixel coordinates of the two-dimensional image. The identification key information is the pixel coordinates used in calculation of the three-dimensional coordinates. The data processing unit is configured to: generate the one or more reference parameters in association with the pixel coordinates based on the two-dimensional image.

### Feature 9

In the estimation device according to any one of features 2 to 6, the vehicle further includes a second type motion sensor including one or more sensors for measuring one or more motion parameters indicative of a travel state of the vehicle. The plurality of types of parameters include the one or more motion parameters acquired by the second type motion sensor and one or more internal parameters of the at least one of the plurality of cameras. The one or more reference parameters include at least one of the one or more motion parameters and the one or more internal parameters. The identification key information is a chronological time when the two-dimensional image was acquired. The data processing unit is configured to: acquire the one or more reference parameters and the identification key information in association with each other from at least one of the second type motion sensor and the at least one of the plurality of cameras.

### Feature 10

A method for estimating an environment around a vehicle using a plurality of cameras, includes: (a) a coordinate calculation step for calculating a group of three-dimensional coordinates representing a position of an element disposed in an environment around the vehicle using visual odometry based on a two-dimensional image acquired by at least one of the plurality of cameras; (b) an information integration step for acquiring each three dimensional coordinate of the group of three-dimensional coordinates, one or more reliability scores corresponding to one or more reference parameters among a plurality of types of parameters related to reliability of the three-dimensional coordinates, and identification key information for specifying the one or more reliability scores corresponding to the three-dimensional coordinates, the one or more reliability scores being determined based on relationship information representing a relationship between the one or more reference parameters and the one or more reliability scores; an information integration step for generating a plurality of data points by integrating the three-dimensional coordinates and the one or more reliability scores based on the identification key information; and (c) a generation step for receives the plurality of data points as input and generating visual information from the plurality of data points using a machine learning model that has been preliminarily trained to generate the visual information that visually represents the element according to the one or more reliability scores included in the plurality of data points.

Reference numeral 110 represents an estimation device, reference numeral 111a represents a coordinate calculation unit, reference numeral 111b represents an information integration unit, reference numeral 111c represents a generation unit, reference numeral 120 represents a camera, reference numeral Ca represents a vehicle, reference numeral Dc represents a reliability score, reference numeral I2di represents a two-dimensional image, reference numeral I2dc represents a three-dimensional coordinate, reference numeral Ia represents an identification key information, reference numeral Idp represents a data point, reference numeral Ig represents a visual information, reference numeral Im represents a machine learning model, reference numeral Ir represents a relationship information, and reference numeral Ps represents a reference parameter.

It is noted that a flowchart or the processing of the flowchart in the present application includes sections (also referred to as steps), each of which is represented, for instance, as S100. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An estimation device mounted on a vehicle equipped with a plurality of cameras, the estimation device comprising:
at least one processor with a memory storing computer program code, wherein
the at least one processor with the memory is configured to cause the estimation device to execute:
calculating a group of three-dimensional coordinates representing a position of an element disposed in an environment around the vehicle using visual odometry based on a two-dimensional image acquired by at least one of the plurality of cameras;
acquiring each three-dimensional coordinate of the group of the three-dimensional coordinates;
acquiring one or more reliability scores corresponding to one or more reference parameters among a plurality of types of parameters related to reliability of the three-dimensional coordinates, and identification key information for specifying the one or more reliability scores corresponding to the three-dimensional coordinates, the one or more reliability scores being determined based on relationship information representing a relationship between the one or more reference parameters and the one or more reliability scores;
generating a plurality of data points by integrating the three-dimensional coordinates and the one or more reliability scores based on the identification key information; and
receiving the plurality of data points as input and generates visual information from the plurality of data points generated in the generating of the plurality of data points using a machine learning model that has been preliminarily trained to generate the visual information that visually represents the element according to the one or more reliability scores included in the plurality of data points.

2. The estimation device according to claim 1,wherein:
the at least one processor with the memory is configured to cause the estimation device to execute:
calculating a group of three-dimensional coordinates representing a position of an element disposed in an environment around the vehicle using visual odometry based on a two-dimensional image acquired by at least one of the plurality of cameras as a coordinate calculation unit;
acquiring each three-dimensional coordinate of the group of the three-dimensional coordinates as an information integration unit;
acquiring one or more reliability scores corresponding to one or more reference parameters among a plurality of types of parameters related to reliability of the three-dimensional coordinates, and identification key information for specifying the one or more reliability scores corresponding to the three-dimensional coordinates, the one or more reliability scores being determined based on relationship information representing a relationship between the one or more reference parameters and the one or more reliability scores as an information integration unit;
generating a plurality of data points by integrating the three-dimensional coordinates and the one or more reliability scores based on the identification key information as an information integration unit; and
receiving the plurality of data points as input and generates visual information from the plurality of data points generated in the generating of the plurality of data points using a machine learning model that has been preliminarily trained to generate the visual information that visually represents the element according to the one or more reliability scores included in the plurality of data points as a generation unit.

3. The estimation device according to claim 2, further comprising:
a data processing unit which is configured by at least one processor with a memory, wherein:
the data processing unit is configured to:
acquire the one or more reference parameters;
determine the one or more reliability scores based on the one or more reference parameters and the relationship information; and
acquire the identification key information corresponding to the three-dimensional coordinates; and
the information integration unit acquires the identification key information corresponding to the three-dimensional coordinates and the one or more reliability scores which are associated with each other from the data processing unit, and acquires the identification key information determined based on the two-dimensional image by the coordinate calculation unit.

4. The estimation device according to claim 3, wherein:
the vehicle further includes a first type motion sensor including at least one of an inertial sensor and a wheel speed sensor; and
the coordinate calculation unit further calculates the three-dimensional coordinates using a change in position and a change in attitude angle of the at least one of the plurality of cameras acquired based on a plurality of acquired values of the first type motion sensor.

5. The estimation device according to claim 4, wherein:
the first type motion sensor does not include the wheel speed sensor but includes the inertial sensor.

6. The estimation device according to claim 4, wherein:
the first type motion sensor does not include the inertial sensor but includes the wheel speed sensor.

7. The estimation device according to claim 4, wherein:
the first type motion sensor includes both the wheel speed sensor and the inertial sensor.

8. The estimation device according to claim 3, wherein:
the plurality of types of parameters include a plurality of VO (Visual Odometry) parameters acquired in calculation of the group of three-dimensional coordinates using the visual odometry;
the identification key information is the three-dimensional coordinates; and
the data processing unit acquires the one or more reference parameters and the identification key information in association with each other from the coordinate calculation unit.

9. The estimation device according to claim 3, wherein:
the plurality of types of parameters include a plurality of element parameters acquired by identifying a component element in the two-dimensional image and associated with pixel coordinates of the two-dimensional image;
the identification key information is the pixel coordinates used in calculation of the three-dimensional coordinates; and
the data processing unit is configured to:
generate the one or more reference parameters in association with the pixel coordinates based on the two-dimensional image.

10. The estimation device according to claim 3, wherein:
the vehicle further includes a second type motion sensor including one or more sensors for measuring one or more motion parameters indicative of a travel state of the vehicle;
the plurality of types of parameters include the one or more motion parameters acquired by the second type motion sensor and one or more internal parameters of the at least one of the plurality of cameras;
the one or more reference parameters include at least one of the one or more motion parameters and the one or more internal parameters;
the identification key information is a chronological time when the two-dimensional image was acquired; and
the data processing unit is configured to:
acquire the one or more reference parameters and the identification key information in association with each other from at least one of the second type motion sensor and the at least one of the plurality of cameras.

11. The estimation device according to claim 1, wherein:
the estimation device constitutes a drive support system that executes an autonomous driving operation based on the visual information by determining a driving route according to the environment around the vehicle.

12. The estimation device according to claim 11, wherein:
the element disposed in the environment around the vehicle includes at least one of another vehicle, a pedestrian, an utility pole, a traffic lane, and a road sign;
the one or more reference parameters includes at least one of: an orientation of a point cloud and a distance of the point cloud;
the point cloud represents the element disposed in the environment around the vehicle and is generated in the three-dimensional space;
the one or more reliability scores is an index that indicates a degree of reliability of the three-dimensional coordinates of a feature point of the element;
the feature point of the element is a point that is more easily distinguishable from surrounding pixels than another point and includes at least one of: an edge of the element; and a corner of the element;
the reliability score varies depending on the one or more reference parameters;
the identification key information includes at least one of: the three-dimensional coordinates; acquisition time when one or more motion parameters are acquired from a second type motion sensor for measuring the one or more motion parameters indicative of a travel state of the vehicle; and acquisition time when one or more internal parameters of the at lest one of the plurality cameras are acquired from the at lest one of the plurality cameras; and
the visual information is information that visually represents the element disposed in the environment around the vehicle, and the visual information includes a bird's-eye view image of the vehicle viewed from above.

13. A method for estimating an environment around a vehicle using a plurality of cameras, comprising:
(a) a coordinate calculation step for calculating a group of three-dimensional coordinates representing a position of an element disposed in an environment around the vehicle using visual odometry based on a two-dimensional image acquired by at least one of the plurality of cameras;
(b) an information integration step for acquiring each three dimensional coordinate of the group of three-dimensional coordinates, one or more reliability scores corresponding to one or more reference parameters among a plurality of types of parameters related to reliability of the three-dimensional coordinates, and identification key information for specifying the one or more reliability scores corresponding to the three-dimensional coordinates, the one or more reliability scores being determined based on relationship information representing a relationship between the one or more reference parameters and the one or more reliability scores; and generating a plurality of data points by integrating the three-dimensional coordinates and the one or more reliability scores based on the identification key information; and
(c) a generation step for receiving the plurality of data points as input and generating visual information from the plurality of data points using a machine learning model that has been preliminarily trained to generate the visual information that visually represents the element according to the one or more reliability scores included in the plurality of data points.

14. The method for estimating the environment around the vehicle according to claim 13, wherein:
the method for estimating the environment around the vehicle is used for a drive support system that executes an autonomous driving operation based on the visual information by determining a driving route according to the environment around the vehicle.

15. The method for estimating the environment around the vehicle according to claim 14, wherein:
the element disposed in the environment around the vehicle includes at least one of another vehicle, a pedestrian, an utility pole, a traffic lane, and a road sign;
the one or more reference parameters includes at least one of: an orientation of a point cloud and a distance of the point cloud;
the point cloud represents the element disposed in the environment around the vehicle and is generated in the three-dimensional space;
the one or more reliability scores is an index that indicates a degree of reliability of the three-dimensional coordinates of a feature point of the element;
the feature point of the element is a point that is more easily distinguishable from surrounding pixels than another point and includes at least one of: an edge of the element; and a corner of the element;
the reliability score varies depending on the one or more reference parameters;
the identification key information includes at least one of: the three-dimensional coordinates; acquisition time when one or more motion parameters are acquired from a second type motion sensor for measuring the one or more motion parameters indicative of a travel state of the vehicle; and acquisition time when one or more internal parameters of the at lest one of the plurality cameras are acquired from the at lest one of the plurality cameras; and
the visual information is information that visually represents the element disposed in the environment around the vehicle, and the visual information includes a bird's-eye view image of the vehicle viewed from above.

16. A non-transitory tangible computer readable storage medium comprising instructions being executed by a computer, the instructions including a computer-implemented method for estimating an environment around a vehicle using a plurality of cameras,
the instructions including:
calculating a group of three-dimensional coordinates representing a position of an element disposed in an environment around the vehicle using visual odometry based on a two-dimensional image acquired by at least one of the plurality of cameras;
acquiring each three dimensional coordinate of the group of three-dimensional coordinates, one or more reliability scores corresponding to one or more reference parameters among a plurality of types of parameters related to reliability of the three-dimensional coordinates, and identification key information for specifying the one or more reliability scores corresponding to the three-dimensional coordinates, the one or more reliability scores being determined based on relationship information representing a relationship between the one or more reference parameters and the one or more reliability scores;
generating a plurality of data points by integrating the three-dimensional coordinates and the one or more reliability scores based on the identification key information; and
receiving the plurality of data points as input and generating visual information from the plurality of data points using a machine learning model that has been preliminarily trained to generate the visual information that visually represents the element according to the one or more reliability scores included in the plurality of data points.

17. The non-transitory tangible computer readable storage medium according to claim 16, wherein:
the computer-implemented method for estimating the environment around the vehicle is used for a drive support system that executes an autonomous driving operation based on the visual information by determining a driving route according to the environment around the vehicle.

18. The non-transitory tangible computer readable storage medium according to claim 17, wherein:
the element disposed in the environment around the vehicle includes at least one of another vehicle, a pedestrian, an utility pole, a traffic lane, and a road sign;
the one or more reference parameters includes at least one of: an orientation of a point cloud and a distance of the point cloud;
the point cloud represents the element disposed in the environment around the vehicle and is generated in the three-dimensional space;
the one or more reliability scores is an index that indicates a degree of reliability of the three-dimensional coordinates of a feature point of the element;
the feature point of the element is a point that is more easily distinguishable from surrounding pixels than another point and includes at least one of: an edge of the element; and a corner of the element;
the reliability score varies depending on the one or more reference parameters;
the identification key information includes at least one of: the three-dimensional coordinates; acquisition time when one or more motion parameters are acquired from a second type motion sensor for measuring the one or more motion parameters indicative of a travel state of the vehicle; and acquisition time when one or more internal parameters of the at lest one of the plurality cameras are acquired from the at lest one of the plurality cameras; and
the visual information is information that visually represents the element disposed in the environment around the vehicle, and the visual information includes a bird's-eye view image of the vehicle viewed from above.
